(19) United States
(12) Patent Application Publication
(10) Pub. No.: US 2021/0082647 A1
(43) Pub. Date: Mar. 18, 2021

(54) RELAY

(71) Applicant: OMRON Corporation, Kyoto-shi (JP)

(72) Inventors: Hiroyuki HARIMOCHI, Kumamoto-shi (JP); Ryota MINOWA, Yamaga-shi (JP); Naoki KAWAGUCHI, Yame-shi (JP); Shinichi OGAWA, Kikuchi-shi (JP); Kohei OTSUKA, Omuta-shi (JP); Hiroyuki IWASAKA, Kamimashiki-gun (JP); Kazuhiro TSUTSUI, Kumamoto-shi (JP)

(73) Assignee: OMRON Corporation

(21) Appl. No.: 17/012,065

(22) Filed: Sep. 4, 2020

(30) Foreign Application Priority Data
Sep. 13, 2019 (JP) 2019-167371

(51) Int. Cl. H01H 50/02; H01H 50/42; H01H 50/20

(52) U.S. Cl. CPC H01H 50/02; H01H 50/546; H01H 50/20; H01H 50/42

(57) ABSTRACT

A relay includes a fixed terminal, a movable contact piece, a holder, a drive shaft, a contact case, a magnetic field generation member, and an inner member. The drive shaft is connected to the holder on a side close to the first end of the drive shaft. The magnetic field generation member is arranged around the contact case and is configured to generate a magnetic field in which an arc generated between the fixed contact and the movable contact extends in a lateral direction of the movable contact piece. The inner member includes a rotation preventing portion for restricting rotation of the holder around the drive shaft. The rotation preventing portion is arranged so as to contact the holder at a position closer to a second end of the drive shaft than the movable contact piece and closer to the drive shaft than the movable contact.

### CROSS-REFERENCE TO RELATED APPLICATION

This application claims priority to Japanese Patent Application No. 2019-167371, filed Sep. 13, 2019. The contents of that application are incorporated by reference herein in their entirety.

### FIELD

The present invention relates to a relay.

### BACKGROUND

A plunger-type relay is known as a relay that opens and closes an electric circuit. In the plunger type relay, when a movable contact piece moves in a direction in which the movable contact piece comes into contact with a fixed contact or a direction in which the movable contact piece separates from the fixed contact, the movable is likely to rotate around the axis of a drive shaft. For this reason, for example, in Japanese Laid-Open Patent Publication No. 2013-187134, a contact case is provided with a rotation preventing portion for restricting rotation of the movable contact piece around the drive shaft.

### SUMMARY

The contact case is provided with a space for extending an arc generated between the fixed contact and the movable contact. For example, in Japanese Laid-Open Patent Publication No. 2014-110094, a pair of magnets is arranged so that different poles face each other in the longitudinal direction of the movable contact piece, and a Lorentz force acts on the arc and the arc is extended in the lateral direction of the movable contact piece.

In Japanese Laid-Open Patent Publication No. 2013-187134, since the rotation preventing portion is provided so as to project from the inner wall of the contact case in order to ensure a sufficient space for extending the arc, the size of the contact case is likely to increase. In particular, in recent years, miniaturization of relays has been demanded, and in order to facilitate miniaturization of the contact case, it is necessary to efficiently secure a space for extending the arc.

An object of the present invention is to provide a relay capable of efficiently securing a space for extending an arc.

A relay according to one aspect of the present invention includes a fixed terminal, a movable contact piece, a holder, a drive shaft, a contact case, a magnetic field generation member, and an inner member. The fixed terminal includes a fixed contact. The movable contact piece includes a movable contact arranged to face the fixed contact. The movable contact piece is configured to move in a moving direction including a first direction in which the movable contact comes into contact with the fixed contact and a second direction in which the movable contact separates from the fixed contact. The holder holds the movable contact piece. The drive shaft includes a first end and a second end opposite to the first end. The drive shaft extends in the moving direction of the movable contact piece and is connected to the holder on a side close to the first end of the drive shaft. The contact case accommodates the fixed contact, the movable contact piece, and the holder. The magnetic field generation member is configured to generate a magnetic field in which an arc generated between the fixed contact and the movable contact extends in a lateral direction of the movable contact piece. The inner member is a separate body from the contact case. The inner member includes a rotation preventing portion for restricting rotation of the holder around the drive shaft. The rotation preventing portion is arranged so as to contact the holder at a position closer to the second end of the drive shaft than the movable contact piece and closer to the drive shaft than the movable contact.

In this relay, the rotation preventing portion is arranged so as to contact the holder at a position closer to the second end of the drive shaft than the movable contact piece and closer to the drive shaft than the movable contact. Accordingly, the space for extending the arc can be secured on the second end side of the drive shaft in the movable contact piece, so that the space for extending the arc can be efficiently secured. As a result, the relay can be easily downsized. Further, the contact case can be more easily downsized as compared with the case where the rotation preventing portion is provided so as to project from the inner wall of the contact case. Further, since the rotation preventing portion is provided on the inner member that is a separate body from the contact case, the degree of freedom of arrangement within the contact case is improved.

The contact case may has an opening that toward the second end of the drive shaft. The inner member may further include a base portion arranged to cover the opening of the contact case. The rotation preventing portion may project from the base portion toward the movable contact piece. In this case, since the inner member is arranged so as to cover the opening, the space for extending the arc can be formed by the inner member and the case member. Further, the rotation preventing portion can be easily formed.

The inner member may further include a tubular portion that extends from the base portion in the moving direction and into which the drive shaft is inserted. In this case, the drive shaft can be supported by the tubular portion, and the movement of the drive shaft can be guided by the tubular portion.

The holder may include a plurality of contact portions configured to contact the rotation preventing portion. The plurality of contact portions may be arranged to face the rotation preventing portion in a longitudinal direction of the movable contact piece. In this case, the rotation angle of the holder around the drive axis can be effectively suppressed by the rotation preventing portion.

The plurality of contact portions and the rotation preventing portion may extend parallel to the lateral direction of the movable contact piece. Even in this case, the rotation angle of the holder around the drive axis can be effectively suppressed by the rotation preventing portion.

The plurality of contact portions may be arranged without overlapping the movable contact piece in the moving direction of the movable contact piece. In this case, the rotation angle of the holder around the drive axis can be more effectively suppressed by the rotation preventing portion.

The holder may include a pedestal portion on which the movable contact piece is placed, a leg portion extending from both ends of the pedestal portion in the lateral direction of the movable contact piece toward the second end of the drive shaft, and a part of clamping portions clamping the movable contact piece. The pair of clamping portions may be formed by bending a part of the leg portion toward the first end of the drive shaft. In this case, the movable contact piece can be held by the holder with a simple structure.

At least a part of the inner member may be formed of an insulating material. In this case, a breaking performance can be improved by the inner member.

The plurality of contact portions and the rotation preventing portion are made of a metal member. In this case, for example, it is possible to prevent the rotation preventing portion from being scraped as compared with the case where the rotation preventing portion is formed of resin.

### BRIEF DESCRIPTION OF THE DRAWINGS

FIG. 1 is a longitudinal sectional view of a relay.

FIG. 2 is an enlarged view of surroundings of a contact device of FIG. 1.

FIG. 3 is a view of the inside of the contact case as viewed from a first end side.

FIG. 4 is a perspective view of the inside of the contact case as viewed from the first end side.

FIG. 5 is a perspective view of a holder.

FIG. 6 is a view showing a modified example of an inner case.

### DETAILED DESCRIPTION

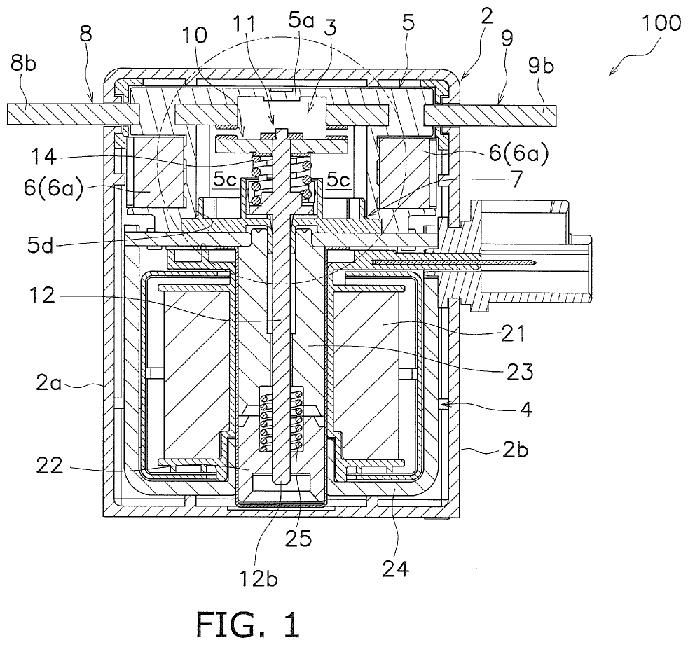

Hereinafter, embodiment of a relay 100 according to one aspect of the present invention will be described with reference to the drawings. When referring to the drawings, an upper side in FIG. 1 is referred to as “up”, a lower side is referred to as “down”, a left side is referred to as “left”, and a right side is referred to as “right” in order to facilitate understanding of the description. In addition, a direction orthogonal to the paper surface of FIG. 1 will be described as a front-back direction. These directions are defined for convenience of explanation, and do not limit an arrangement direction of the relay 100.

The relay 100 includes a housing 2, a contact device 3, a drive device 4, a contact case 5, a magnetic field generation member 6, and an inner member 7.

The housing 2 has a substantially rectangular box shape and is made of an insulating material. The contact device 3, the drive device 4, the contact case 5, and the inner member are housed inside the housing 2.

The contact device 3 includes a first fixed terminal 8, a second fixed terminal 9, a movable contact piece 10, and a movable mechanism 11.

The first fixed terminal 8 and the second fixed terminal 9 are plate-shaped terminals and extend in the left-right direction. The first fixed terminal 8 and the second fixed terminal 9 extend both inside and outside the housing 2. The first fixed terminal 8 and the second fixed terminal 9 are arranged apart from in the left-right direction. The first fixed terminal 8 and the second fixed terminal 9 are made of a conductive material.

The first fixed terminal 8 includes a first fixed contact 8a and a first external connection portion 8b. The first fixed contact 8a is arranged inside the housing 2. The first external connection portion 8b projects leftward from the housing 2. The first fixed contact 8a is provided separately from the first fixed terminal 8. The first fixed contact 8a may be integrated with the first fixed terminal 8.

The second fixed terminal 9 includes a second fixed contact 9a and a second external connection portion 9b. The second fixed contact 9a is arranged inside the housing 2. The second external connection portion 9b projects rightward from the housing 2. The second fixed contact 9a is provided separately from the second fixed terminal 9. The second fixed contact 9a may be integrated with the second fixed terminal 9. Note that, below, the first fixed contact 8a and the second fixed contact 9a may be described as the fixed contacts 8a, 9a.

The movable contact piece 10 is a plate shape member that is long in one direction, and extends in the left-right direction inside the housing 2. The movable contact piece 10 is made of a conductive material. A longitudinal direction of the movable contact piece 10 matches the left-right direction. Moreover, a lateral direction of the movable contact piece 10 matches the front-back direction.

The movable contact piece 10 includes a first movable contact 10a and a second movable contact 10b. The first movable contact 10a is arranged at a position facing the first fixed contact 8a and can contact the first fixed contact 8a. The second movable contact 10b is arranged at a position facing the second fixed contact 9a and can contact the second fixed contact 9a. The first movable contact 10a and the second movable contact 10b are provided separately from the movable contact piece 10. Note that, the movable contacts 10a, 10b may be integrated with the movable contact piece 10. Note that, below, the first movable contact 10a and the second movable contact 10b may be described as the movable contacts 10a, 10b.

The movable contact piece 10 is configured to move in a moving direction including a contact direction in which the movable contacts 10a, 10b come into contact with the fixed contacts 8a, 9a and a separation direction in which the movable contacts 10a, 10b are separated from the fixed contacts 8a, 9a. The contact direction is a direction in which the movable contact piece 10 approaches the fixed contacts 8a, 9a (upward in FIG. 1). The separation direction is a direction in which the movable contact piece 10 separates from the fixed contacts 8a 9a (downward in FIG. 1). Therefore, the contact direction and the separation direction are parallel to the up-down direction.

The movable mechanism 11 includes a drive shaft 12, a retaining member 13, a contact spring 14, and a holder 30. The drive shaft 12 extends in the moving direction of the movable contact piece 10. That is, the drive shaft 12 extends in the up-down direction. The drive shaft 12 includes a first end 12a, a second end 12b, and a flange portion 12c. In the present embodiment, the first end 12a is an upper end of the drive shaft 12. The second end 12b is an end opposite to the first end 12a, and is a lower end of the drive shaft 12.

Therefore, in the present embodiment, a first end 12a side is the upper side and a second end 12b side is the lower side.

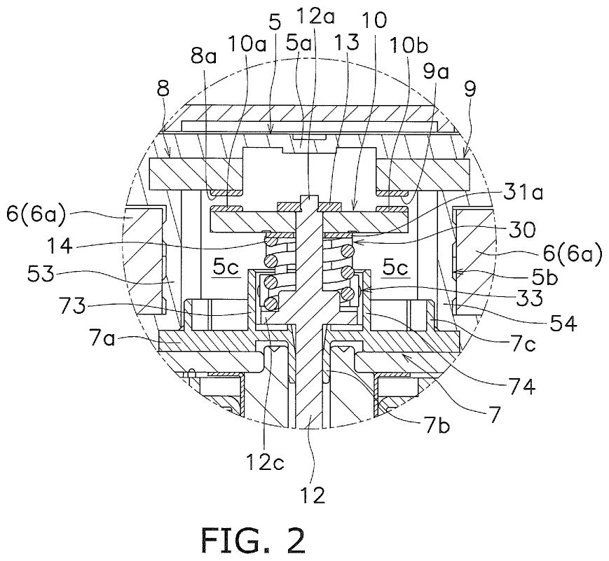

The drive shaft 12 is connected to the holder 30 on the first end 12a side. The first end 12a penetrates the movable contact piece 10 in the up-down direction and projects upward from the movable contact piece 10. The flange portion 12c is arranged between the first end 12a and the second end 12b. As illustrated in FIG. 2, the flange portion 12c is arranged above a described later cylindrical portion 7b of the inner member 7.

The retaining member 13 retains the movable contact piece 10 from the drive shaft 12. The retaining member 13 is a ring shape member, and is fixed to the drive shaft 12 on top of the movable contact piece 10. The contact spring 14 is arranged between the flange portion 12c of the drive shaft 12 and the holder 30. The contact spring 14 biases the movable contact piece 10 in the contact direction via the holder 30. The holder 30 holds the movable contact piece 10. The holder 30 is rotatable around the drive shaft 12 together with the movable contact piece 10. Details of the holder 30 will be described later.

The drive device 4 moves the movable mechanism 11 in the contact direction and the separating direction by the electromagnetic force. The drive device 4 includes a coil 21, a movable iron core 22, a fixed iron core 23, a yoke 24, and a return spring 25.

When a voltage is applied and the coil 21 is excited, the coil 21 generates the electromagnetic force that moves the movable iron core 22 in the contact direction. The movable iron core 22 is coupled to the drive shaft 12 so as to be integrally movable. The fixed iron core 23 is arranged at a position facing the movable iron core 22. The yoke 24 is arranged so as to surround the coil 21. The return spring 25 is arranged between the movable iron core 22 and the fixed iron core 23. The return spring 25 biases the movable iron core 22 in the separation direction. Since the operation of the relay is the same as the conventional one, detailed description thereof will be omitted. Note that, FIG. 1 shows a state where no voltage is applied to the coil 21.

The contact case 5 is made of an insulating material. The contact case 5 has a box shape and opens toward the second end 12b side (downward in FIG. 1). Specifically, the contact case 5 includes a cover portion 5a and a wall portion 5b.

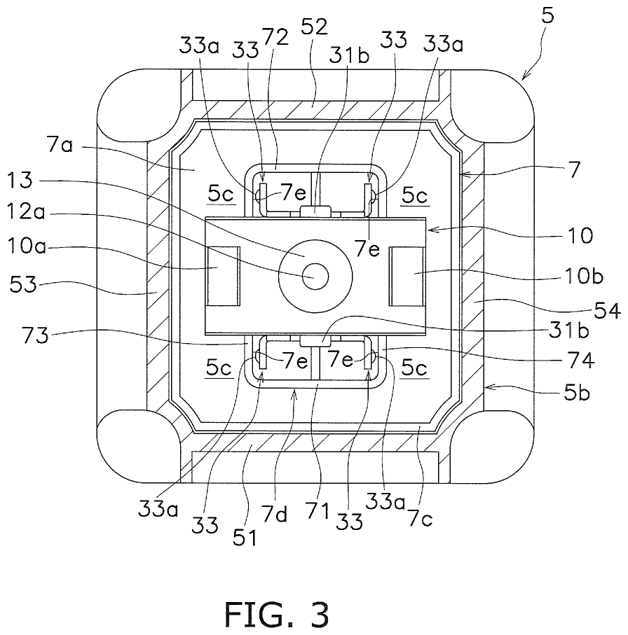

The cover portion 5a is arranged above the contact device 3 and covers the contact device 3 from above in the housing 2. The cover portion 5a extends in the front-back direction and the up-down direction. As illustrated in FIG. 3, the wall portion 5b is formed in a substantially rectangular shape as viewed from the first end 12a side, and extends from the cover portion 5a to the second end 12b side. Specifically, the wall portion 5b includes first to fourth wall portions 51 to 54. The first wall portion 51 and the second wall portion 52 are arranged to face each other in the lateral direction of the movable contact piece 10. The third wall portion 53 and the fourth wall portion 54 are arranged to face each other in the longitudinal direction of the movable contact piece 10. A length of the first wall portion 51 and the second wall portion 52 in the left-right direction is equal to a length of the third wall portion 53 and the fourth wall portion 54 in the front-rear direction.

The fixed contacts 8a 9a, the movable contact piece 10, and the holder 30 are housed in the contact case 5. In the present embodiment, the contact case 5 further accommodates the first end 12a of the drive shaft 12, the flange portion 12c of the drive shaft 12, and the contact spring 14. As illustrated in FIGS. 1 to 3, an arc extension space 5c is provided in the contact case 5 to extend an arc generated between the first fixed contact 8a and the first movable contact 10a and between the second fixed contact 9a and the second movable contact 10b. The arc extension space 5c is provided so as to extend in the lateral direction of the movable contact piece 10 from the movable contacts 10a, 10b, and to the second end 12b side near both ends of the movable contact piece 10. The arc extension space 5c is formed by the contact case 5 and the inner member 7

The magnetic field generation member 6 is arranged around the contact case 5 and generates a magnetic field in which the arc extends in the lateral direction of the movable contact piece 10. The magnetic field generation member 6 includes a pair of permanent magnets 6a. The pair of permanent magnets 6a is arranged outside the contact case 5 so that different poles face each other in the longitudinal direction of the movable contact piece 10, and generates a magnetic flux in the contact case 5 in the left-right direction. Thereby, for example, when a current flows in the up-down direction between the first fixed contact 8a and the first movable contact 10a, the Lorentz force from the movable contacts 10a, 10b toward the first wall portion 51 or the second wall portion 52 acts on the arc. By acting on the arc, the arc is extended in the direction toward the first wall portion 51 or the second wall portion 52. Then, the arc is stretched in the arc extension space 5c, and the arc is quickly extinguished.

The inner member 7 is provided separately from the contact case 5. At least a part of the inner member 7 is formed of, for example, an insulating material. In this embodiment, the entire inner member 7 is made of an insulating material. The inner member 7 is arranged inside the contact case 5. The inner member 7 is arranged so as to cover the second end 12b side of the contact case 5.

The inner member 7 includes a base portion 7a, a tubular portion 7b, an outer wall portion 7c, an inner wall portion 7d, and a rotation preventing portion 7e. The base portion 7a is formed in a substantially rectangular shape and is arranged to cover an opening 5d of the contact case 5. The drive shaft 12 penetrates a center of the base portion 7a in the up-down direction. The tubular portion 7b extends in the moving direction from the base portion 7a, and the drive shaft 12 is inserted therein. Specifically, the tubular portion 7b, near the center of the base portion 7a, extends from the base portion 7a toward the second end 12b side. The tubular portion 7b supports the drive shaft 12 and guides the up-down movement of the drive shaft 12.

The outer wall portion 7c is formed in a substantially rectangular shape as viewed from the first end 12a side. The outer wall portion 7c extends from the base portion 7a to the first end 12a side along the wall portion 5b of the contact case 5.

The inner wall portion 7d is located closer to the drive shaft 12 than the outer wall portion 7c. The inner wall portion 7d is formed in a substantially rectangular shape as viewed from the first end 12a side, and extends from the base portion 7a to the first end 12a side. The inner wall portion 7d is arranged closer to the second end 12b side than the movable contact piece 10. The flange portion 12c of the drive shaft 12, a part of the contact spring 14 and a part of the holder 30 are housed in the space surrounded by the inner wall portion 7d.

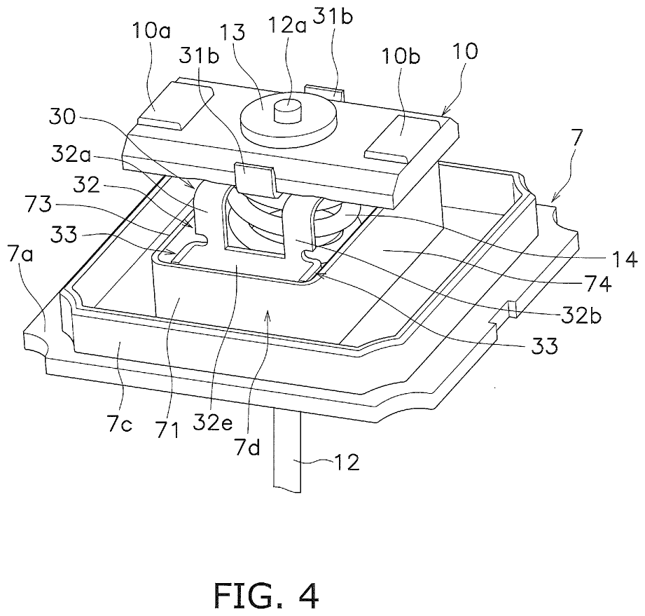

As illustrated in FIGS. 3 and 4, the inner wall portion 7d is formed longer in the front-back direction than in the left-right direction. Specifically, the inner wall portion 7d includes first to fourth wall portions 71 to 74. The first wall portion 71 and the second wall portion 72 extend in a direction parallel to the longitudinal direction of the movable contact piece 10. That is, the first wall portion 71 and the second wall portion 72 extend in the left-right direction. The first wall portion 71 and the second wall portion 72 are arranged to face each other in the front-back direction. The third wall portion 73 and the fourth wall portion 74 extend parallel to the lateral direction of the movable contact piece 10. That is, the third wall portion 73 and the fourth wall portion 74 extend in the front-back direction. The third wall portion 73 and the fourth wall portion 74 are arranged to face each other in the left-right direction of the movable contact piece 10.

Lengths of the first wall portion 71 and the second wall portion 72 in the left-right direction are shorter than lengths of the third wall portion 73 and the fourth wall portion 74 in the front-back direction. The length of the first wall portion 71 and the second wall portion 72 in the left-right direction are shorter than the length of the movable contact piece 10 in the left-right direction. The length of the third wall portion 73 and the fourth wall portion 74 in the front-back direction are longer than the length of the movable contact piece 10 in the front-back direction.

The first wall portion 71 is arranged between the first wall portion 51 and the movable contact piece 10 as viewed from the first end 12a side. The second wall portion 72 is arranged between the second wall portion 52 and the movable contact piece 10 as viewed from the first end 12a side. The third wall portion 73 is arranged at a position closer to the drive shaft 12 than the first movable contact 10a. That is, the first movable contact 10a is arranged between the third wall portion 53 and the third wall portion 73 as viewed from the first end 12a side. The fourth wall portion 74 is arranged at a position closer to the drive shaft 12 than the second movable contact 10b. That is, the second movable contact 10b is arranged between the fourth wall portion 54 and the fourth wall portion 74 as viewed from the first end 12a side.

The rotation preventing portion 7e restricts rotation of the holder 30 around the drive shaft 12. The rotation preventing portion 7e projects from the base portion 7a toward the movable contact piece 10. The rotation preventing portion 7e is arranged so as to contact the holder 30 at a position closer to the second end 12b side than the movable contact piece 10 and closer to the drive shaft 12 than the movable contacts 10a and 10b. In the present embodiment, the rotation preventing portion 7e is composed of the third wall portion 73 and the fourth wall portion 74. Therefore, the rotation preventing portion 7e extends parallel to the lateral direction of the movable contact piece 10.

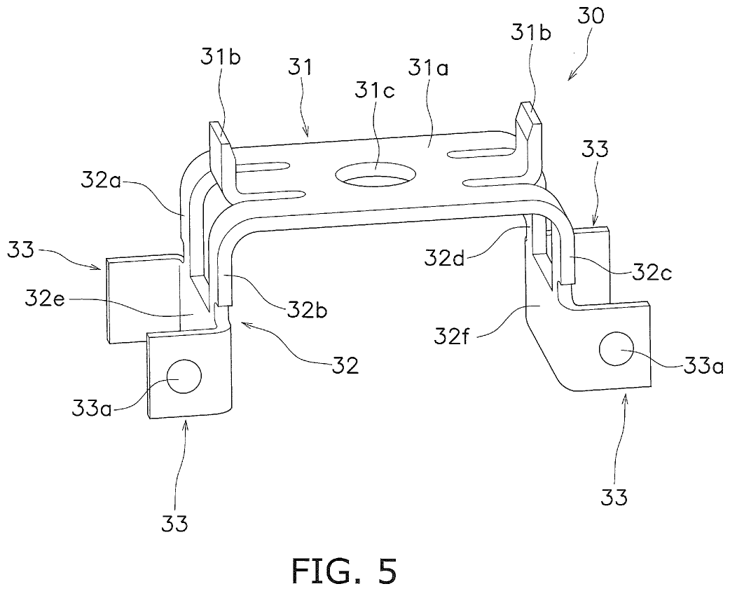

Next, the details of the holder 30 will be described with reference to FIGS. 3 to 5. The holder 30 includes a holding portion 31, a leg portion 32, and a plurality of contact portions 33.

The holding portion 31 includes a pedestal portion 31a, a pair of clamping portions 31b, and a through hole 31c. The pedestal portion 31a extends in the lateral direction of the movable contact piece 10. The pedestal portion 31a is arranged near the center in the longitudinal direction of the movable contact piece 10, and the movable contact piece 10 is placed on the first end 12a side of the pedestal portion 31a. The pedestal portion 31a is in contact with the contact spring 14 on the second end 12b side, and is biased in the contact direction by the contact spring 14.

The pair of clamping portions 31b clamps the lateral side portions of the movable contact piece 10 and holds the movable contact piece 10 on the pedestal portion 31a so as to rotate integrally with the movable contact piece 10. The pair of clamping portions 31b extend from the pedestal portion 31a toward the first end 12a side. The pair of clamping portions 31b is formed by bending a part of the leg portion 32 toward the first end 12a side.

The through hole 31c is a circular hole into which the first end 12a of the drive shaft 12 is inserted, and is formed at the center of the pedestal portion 31a so as to penetrate therethrough in the up-down direction.

The leg portion 32 extends from both ends of the pedestal portion 31a in the lateral direction of the movable contact piece 10 toward the first end side. Specifically, the leg portion 32 includes first to fourth leg portions 32a to 32d. Each of the first to fourth leg portions 32a to 32d extends from the four corners of the pedestal portion 31a toward the second end 12b. The first leg portion 32a and the second leg portion 32b are arranged apart from each other in the left-right direction. The third leg portion 32c and the fourth leg portion 32d are arranged apart from each other in the left-right direction. The pair of clamping portions 31b is arranged between the first leg portion 32a and the second leg portion 32b, and between the third leg portion 32c and the fourth leg portion 32d.

A first connection portion 32e connects the first leg portion 32a and the second leg portion 32b. Specifically, the first connection portion 32e extends in the left-right direction and connects the lower end portion of the first leg portion 32a and the lower end portion of the second leg portion 32b. A second connection portion 32f connects the third leg portion 32c and the fourth leg portion 32d. Specifically, the second connection portion 32f extends in the left-right direction and connects the lower end portion of the third leg portion 32c and the lower end portion of the fourth leg portion 32d.

The plurality of contact portions 33 are arranged inside the inner wall portion 7d and is configured to contact the rotation preventing portion 7e. The plurality of contact portions 33 are arranged so as to face the rotation preventing portion 7e in the longitudinal direction of the movable contact piece 10. The plurality of contact portions 33 extends parallel to the lateral direction of the movable contact piece 10. Specifically, the plurality of contact portions 33 extend in the lateral direction of the movable contact piece 10 from the lower end portion of each of the first to fourth leg portions 32a to 32d. In the present embodiment, the plurality of contact portions 33 extend in a direction away from the lateral center of the movable contact piece 10 as viewed from the first end 12a side. As illustrated in FIG. 3, the plurality of contact portions 33 are arranged without overlapping the movable contact piece 10 in the moving direction of the movable contact piece 10.

The plurality of contact portions 33 each includes a protruding portion 33a protruding in a hemispherical shape toward the inner wall portion 7d. In the present embodiment, when the holder 30 attempts to rotate around the axis of the drive shaft 12, the protruding portions 33a come into contact with the rotation preventing portion 7e, and the rotation of the holder 30 around the drive shaft 12 is restricted. The protruding portions 33a of the plurality of contact portions 33 can contact the inner side surface of the third wall portion 73 and the inner side surface of the fourth wall portion 74.

The height of each of the third wall portion 73 and the fourth wall portion 74 from the base portion 7a is set at a height such that the plurality of contact portions 33 can contact the third wall portion 73 and the third wall portion 73 when the holder 30 is moved in the contact direction by driving the drive device 4.

In the relay 100 configured as described above, the rotation preventing portion 7e is arranged so as to contact the holder 30 at a position closer to the second end 12b side than the movable contact piece 10 and closer to the drive shaft 12 than the movable contacts 10a, 10b. Thereby, the arc extension space 5c can be secured on the second end 12b side of the drive shaft 12 in the movable contact piece 10, so that the arc extension space 5c can be efficiently secured. As a result, the relay can be easily downsized. Further, the contact case 5 can be more easily downsized as compared with the case where the rotation preventing portion 7e is provided so as to project from the inner wall of the contact case 5. Further, since the rotation preventing portion 7e is provided on the inner member 7 that is provided separately from the contact case 5, the degree of freedom of arrangement within the contact case 5 is improved.

Further, since the plurality of contact portions 33 and the rotation preventing portion 7e are arranged to face each other in the longitudinal direction of the movable contact piece 10, a distance between the contact portions 33 can be made larger than that in the case where the contact portions 33 and the rotation preventing portion 7e are arranged to face each other are in the lateral direction of the movable contact piece 10. Specifically, for example, when the plurality of contact portions 33 is brought into contact with the first wall portion 71 and the second wall portion 72, the lengths of the first wall portion 71 and the second wall portion 72 in the left-right direction are shorter than the lengths of third wall portion 73 and the fourth wall portion 74 in the front-back direction. For this reason, the distance between the contact portions 33 contacting the first wall portion 71 and the contact portions 33 contacting the second wall portion 72 becomes narrower. That is, when the plurality of contact portions 33 is brought into contact with the third wall portion 73 and the fourth wall portion 74, the rotation angle of the holder 30 around the drive shaft 12 can be suppressed as compared with the case where the plurality of contact portions 33 is brought into contact with the first wall portion 71 and the second wall portion 72.

While the embodiment of the electromagnetic relay according to one aspect of the present invention has been described, the present invention should not be construed as being limited thereto, and various types of modifications may be made without departing from the spirit or scope of the general inventive concept of the invention.

In the above-described embodiment, the rotation preventing portion 7e is configured by the third wall portion 73 and the fourth wall portion 74, but the structure of the rotation preventing portion 7e is not limited to the above embodiment. The third wall portion 73 and the fourth wall portion 74 may be formed only on a part facing the plurality of contact portions 33. Further, the rotation preventing portion 7e and the plurality of contact portions 33 may be arranged so as to face each other in the lateral direction of the movable contact piece 10. That is, the rotation preventing portion 7e may be configured by the first wall portion 71 and the second wall portion 72.

The structure of the holder 30 is not limited to the above-described embodiment. For example, the protruding portion 33a of the plurality of contact portions 33 may be omitted. The plurality of contact portions 33 may overlap the movable contact piece 10 in the moving direction of the movable contact piece 10.

The configuration of the magnetic field generation member 6 is not limited to the above-described embodiment. Permanent magnets may be arranged near the movable contacts 10a, 10b so as to generate the magnetic flux in the left-right direction.

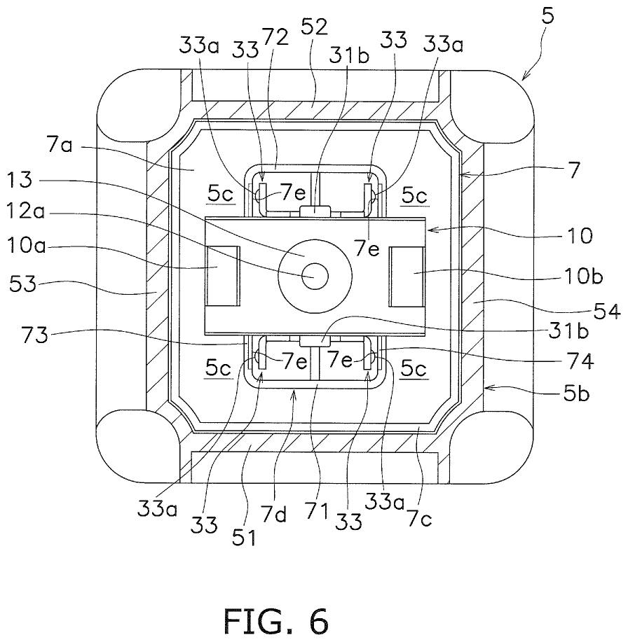

In the above-described embodiment, the entire inner member 7 is made of an insulating material, but as illustrated in FIG. 6, the rotation preventing portion 7e may be made of a metal member. For example, a metal member may be integrally molded with the inner member 7 by insert molding, or a metal piece may be inserted into the inner member 7. The holder 30 is made of metal. In this case, since the plurality of contact portions 33 and the rotation preventing portion 7e are made of a metal member, it is possible to prevent the rotation preventing portion 7e from being scraped as compared with the case where the rotation preventing portion 7e is formed of resin.

1. A relay comprising:
a fixed terminal including a fixed contact;
a movable contact piece including a movable contact arranged to face the fixed contact, the movable contact piece being configured to move in a moving direction including a first direction in which the movable contact comes into contact with the fixed contact and a second direction in which the movable contact separates from the fixed contact;
a holder that holds the movable contact piece;
a drive shaft including a first end and a second end opposite to the first end, the drive shaft extending in the moving direction of the movable contact piece, the drive shaft being connected to the holder on a side close to the first end of the drive shaft;
a contact case that accommodates the fixed contact, the movable contact piece, and the holder;
a magnetic field generation member arranged around the contact case, the magnetic field generation member being configured to generate a magnetic field in which an arc generated between the fixed contact and the movable contact extends in a lateral direction of the movable contact piece; and
an inner member that is a separate body from the contact case and that includes a rotation preventing portion for restricting rotation of the holder around the drive shaft, the rotation preventing portion being arranged so as to contact the holder at a position closer to the second end of the drive shaft than the movable contact piece and closer to the drive shaft than the movable contact.

2. The relay according to claim 1, wherein
the contact case has an opening that opens toward the second end of the drive shaft,
the inner member further includes a base portion arranged to cover the opening of the contact case, and
the rotation preventing portion projects from the base portion toward the movable contact piece.

3. The relay according to claim 2, wherein
the inner member further includes a tubular portion extending from the base portion in the moving direction and into which the drive shaft is inserted.

4. The relay according to claim 1, wherein
the holder includes a plurality of contact portions configured to contact the rotation preventing portion, and
the plurality of contact portions are arranged to face the rotation preventing portion in a longitudinal direction of the movable contact piece.

5. The relay according to claim 4, wherein
the plurality of contact portions and the rotation preventing portion extend parallel to the lateral direction of the movable contact piece.

6. The relay according to claim 5, wherein
the plurality of contact portions are arranged without overlapping the movable contact piece in the moving direction of the movable contact piece.

7. The relay according to claim 1, wherein
the holder includes a pedestal portion on which the movable contact piece is placed, a leg portion extending from both ends of the pedestal portion in the lateral direction of the movable contact piece toward the second end of the drive shaft, and a pair of clamping portions clamping the movable contact piece, the pair of the clamping portions being formed by bending a part of the leg portion toward the first end of the drive shaft.

8. The relay according to claim 1, wherein
at least a part of the inner member is formed of an insulating material.

9. The relay according to claim 1, wherein
the plurality of contact portions and the rotation preventing portion are made of a metal member.
